(19) United States
(12) Patent Application Publication
(10) Pub. No.: US 2025/0058213 A1
(43) Pub. Date: Feb. 20, 2025

(54) Ergonomic and Device Retention Solutions for a Handheld Game Controller

(71) Applicant: Backbone Labs, Inc., Vancouver, WA (US)

(72) Inventors: Maneet Singh Khaira, Vancouver, WA (US); Matty Martin, Fairfax, CA (US); Zachary Scott, Palo Alto, CA (US); Jon Christopher Lake, Sunnyvale, CA (US); Dan Odell, Los Altos Hills, CA (US); Evan Silverman, Emeryille, CA (US)

(73) Assignee: Backbone Labs, Inc., Vancouver, WA (US)

(21) Appl. No.: 18/805,902

(22) Filed: Aug. 15, 2024

Related U.S. Application Data
(60) Provisional application No. 63/533,580, filed on Aug. 18, 2023.

(51) Int. Cl. A63F 13/24

(52) U.S. Cl. CPC A63F 13/24

(57) ABSTRACT

One challenge of designing a handheld game controller to accommodate thicker phones and phone cases is that it tends to make the handheld game controller thicker. A thicker handheld game controller increases weight, volume and material expense. In one embodiment, a handheld game controller is provided with an “overhang” that solves this problem by decoupling increased thickness of the phone from the requirement of increasing controller thickness. This allows for the benefits of broader phone and case support, while maintaining a more-comfortable posture.

### CROSS-REFERENCE TO RELATED APPLICATION

This application claims the benefit of U.S. provisional patent application No. 63/533,580, filed Aug. 18, 2023, which is hereby incorporated by reference.

### BACKGROUND

One challenge of designing a handheld game controller to accommodate thicker phones and phone cases is that it tends to make the handheld game controller thicker. A thicker handheld game controller increases weight, volume and material expense.

### BRIEF DESCRIPTION OF THE DRAWINGS

FIG. 1 is an illustration of poor thumb posture when using a handheld game controller, which is made worse when a thicker case presses the thumb higher up.

FIG. 2 is an illustration of a game controller of an embodiment that comprises an overhang.

FIG. 3 is an illustration of a game controller of an embodiment that denotes a gap between an overhang and a thumb.

FIG. 4 is an illustration of a game controller of an embodiment with a raised top surface to create more space in a cavity for a phone.

FIG. 5 is an illustration of poor thumb posture when using a handheld game controller.

FIG. 6 are illustrations of full case, partial case, and minimal case examples of an embodiment.

FIG. 7 is an illustration of a prior art game controller.

FIG. 8 is an illustration of a speedbump design of an embodiment.

FIG. 9 is a chart of conclusions of an embodiment.

FIG. 10 is an illustration of a game controller of an embodiment that comprises an overhang.

FIG. 11 is an illustration of a game controller of an embodiment having a top surface tilt.

FIGS. 12-13 illustrate a thumb flexion problem.

FIGS. 14-15 illustrate an ergonomic critical Z stack.

FIGS. 16-18 illustrate a mechanical critical Z stack.

FIGS. 19-20 illustrate an ergonomic framework.

FIGS. 21-23 illustrate a thumb flexion problem.

### DETAILED DESCRIPTION

### Brief Introduction

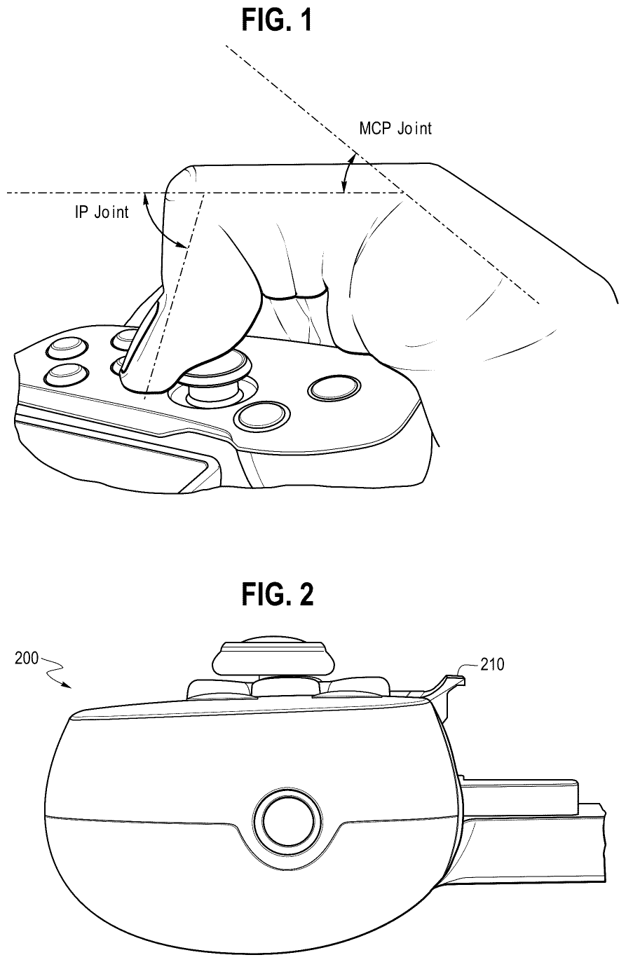

As mentioned above, one challenge of designing a handheld game controller to accommodate thicker phones and phone cases is that it tends to make the handheld game controller thicker. A thicker handheld game controller increases weight, volume and material expense. Most importantly, a thicker handheld game controller reduces comfort and increases risk for musculoskeletal pain by pushing the thumb higher into a less-comfortable posture (e.g., increased IP flexion). FIG. 1 is an illustration of poor thumb posture, which is made worse when a thicker case presses the thumb higher up. We have determined a range of motion (ROM) target from 0-65 degrees for thumb IP flexion during use of our device.

As shown in FIG. 2, in one embodiment, a handheld game controller 200 is provided with an “overhang” 210 that addresses this problem by decoupling increased thickness of the phone from the requirement of increasing controller thickness. This allows for the benefits of broader phone and case support, while maintaining a more comfortable posture.

The overhang 210 (the raised phone coupling surface) localizes the added thickness needed for phone cases away from the controller grip areas to improve comfort. The overhang 210 works by providing a raised surface that is capable of mechanically coupling the phone in the localized area of the phone without burdening the controller 200 with extra thickness.

One aspect of this design is proper coupling with an increased range of phones (relative to a design that does not use the overhang 210). Minimal screen interference with touchscreen interaction (especially “up-swipes”) is provided via variable thickness (chamfer) and minimal overlap. In an alternate embodiment, multiple small overhangs or a notched-out design is used to secure the phone without impeding thumb access. This can support a range of phone thicknesses (i.e., a range of overlap heights for phones), and materials can be chosen for their softness.

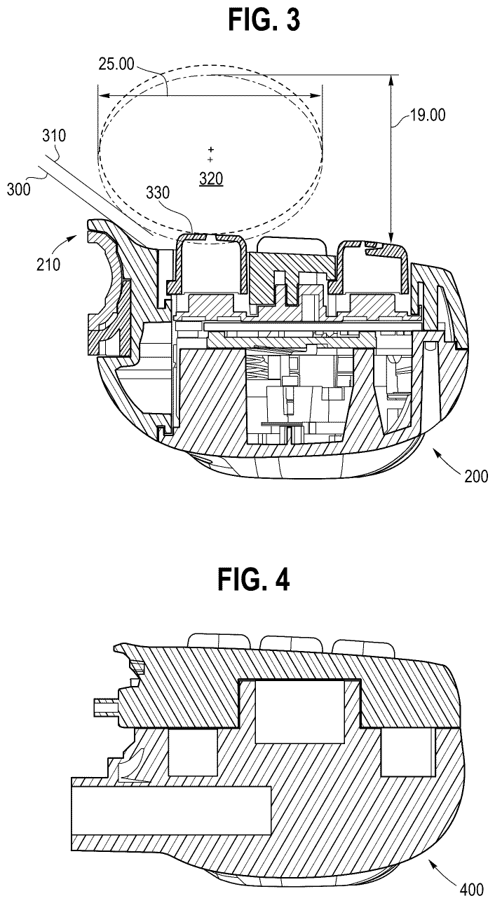

Another aspect of this design is reducing risk of the thumb colliding with the overhang 210 during gameplay (which can be uncomfortable and disruptive to gameplay) by providing appropriate clearance with the thumb. Placement of input affordances relative to the overhang 210 to accommodate thumb clearance of large thumb sizes and different grips in the most extreme input positions—especially in the X dimension—can be provided. Notches in the overhang in the Y dimension would also provide clearance. A desired height of the input affordance relative to the overhang can be provided, and the surface profile of the overhang 210 can be designed to reduce collision risk. In an alternate embodiment, soft materials can be used to mitigate the consequences of collision. As shown in FIG. 3, lines 300 and 310 denote the needed gap between the overhang 210 and the thumb 320 in the most-extreme position (e.g., X-button 330 depressed). This clearance should be in the 0.5 mm-5 mm range for a 75th percentile thumb.

Yet another aspect of this design is reducing controller thickness to provide a more comfortable thumb posture, especially reduced thumb flexion. This is compared with a similar controller design that does not use an overhang.

The top of the input surface can be lowered relative to the grip surface on the bottom. Note that thumb flexion depends on many things, including control placement and grip design. Reduced height is a single aspect of thumb flexion. Grip may be needed on the back, and some bottom curvature may be needed to hold onto that adds thickness.

### Case Support-Staging the Z Budget Problem

In one objective, to support larger phones and phone cases, it was imperative to create more space in the Z dimension. To solve this, we came up with an initial approach: raise the top surface of the gaming controller handle up in the Z dimension (increasing the dimension in the Z dimension) to create more space in the cavity for the phone, making the handles thicker and the product thicker overall. As shown in FIG. 4, the device 400 is a lot thicker overall because we have grown the cavity for the phone in Z dimension (hereinafter referred to as simply “Z”).

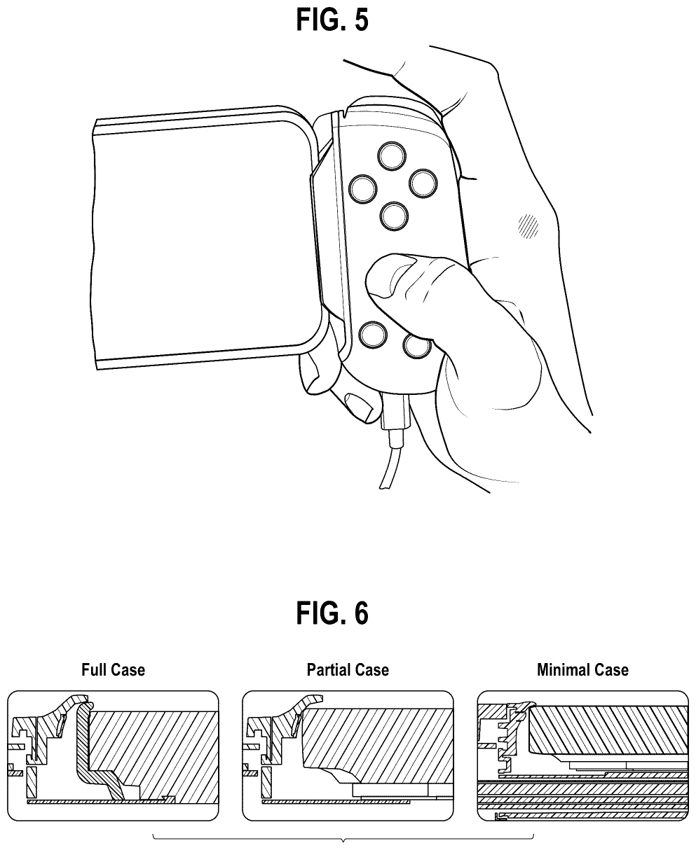

However, we quickly uncovered two issues. First, as you expand the overall Z, the right thumb position becomes increasingly less neutral, which results in increased thumb flexion and thumb pain resulting from increased flexion (MCP/IP/CMC joints) (see FIGS. 1 and 5). This is particularly true of users who aim with the end/tip of their thumb (roughly half of users). We validated via play tests that reported thumb comfort was indeed reduced in the thicker devices for thumb tip users. Most techniques to mitigate this impact require radical revisions to the industrial design and overall form factor, including changes to the external angle of the handles, the overall shape and contouring of the grips, position of the joystick, and so on.

The second issue is that the device form factor becomes significantly larger. The rough amount of Z-depth available for phones in the Backbone One game controller was about 10.5 mm. For true case support, at least 14 mm worth of Z-space is required. Adding an additional 3.5 mm to the surface of the handles would dramatically increase the size, and this can result in aesthetic and portability issues as well as increase complexity for manufacturing and increased materials cost.

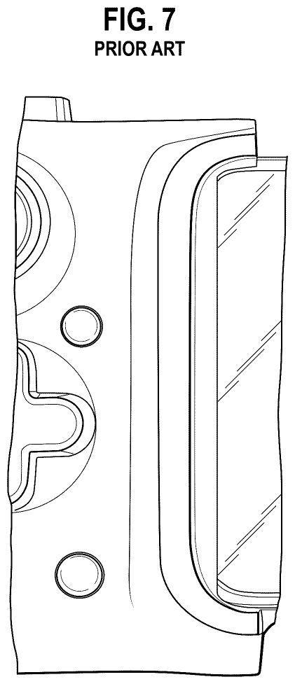

FIG. 6 illustrates full case, partial case, and minimal case examples. The full case example involves an iPhone 15 Pro Plus first party or an Android plus a 2.0 mm case. The partial case example involves an iPhone 15 Pro with no case or an Android plus a 2.0 mm case. The minimal case example involves an iPhone 15 Pro with no case or an Android with a minimal case.

### The Overhang Enables Case Support

We spent months exploring numerous mitigation strategies to somehow work around the thumb comfort issue, such as trying to cleave off hundreds of microns from the overall Z-stack through methods like reducing the depth of the bridge, etc. We then posed a question: is there a way to preserve the ergonomic envelope while somehow creating sufficient space within the Z stack?

In order to achieve this, we determined, after exploring the entire solution space, that the section of the device that clamps down on the phone, referred to herein as the “overhang,” could be elevated above the top surface of the handles, which would result in a best-of-both-worlds scenario-ample Z-height to accommodate more cases, while keeping the controller thinner to provide more comfortable thumb posture and reduce other concerns related to a thicker device.

Prior attempts to address these issues have been plagued by a couple of core issues and therefore failed. One issue is aesthetics. As shown in FIG. 7, these designs produce a hard step where the top surface of the handle, where the input surfaces are typically situated, meets the clamping portion. They also encapsulate the device on the top and bottom, which results in a bracket-like appearance and limits the compatibility of certain styles of devices, such as foldable phones.

Another issue relates to device width constraints. In order to enable this step feature, traditional products are significantly wider than the Backbone One game controller. The significant downside of this approach is that the overall proportions of the device shift dramatically. The ratio between the overall width of the device and height of the device increases, resulting in an overall form that feels disproportionately wide, especially when combined with Android phones, like the Samsung Galaxy S23 Ultra, which are notable for their elongated appearance and general aspect ratio. The result is the device feels wide in the hands during gameplay, compromising comfort and case of use. When compared to dedicated gaming host devices in the handheld form factor like the Nintendo Switch, it can be significantly wider but only half the height. One user remarked that playing on one of these devices felt like you were gaming on an unfolded, outstretched map.

Instead of introducing a substantially wider, and therefore less portable, device or introducing a bracket design that hindered both compatibility and aesthetics, the game controller of this embodiment uses an overhang. To achieve the overhang, several critical dimensions and considerations were explored.

### Overhang Z

We came up with a few different designs that would result in a smoother transition without brackets. In some of these designs, the sharp angle versus the smooth tangent is between the horizontal of the top case and the horizontal of the top of the overhang. Two designs discussed below are the “half-pipe design” and the “speedbump design.” The half-pipe is tangent with the top case but has a sharp corner at the top of the overhang. As shown in FIG. 2, the half pipe design has a gradual transition from the top surface to the section that clamps down on the phone with a minimized flat portion/chamfer. Primarily, it is a smooth S curve.

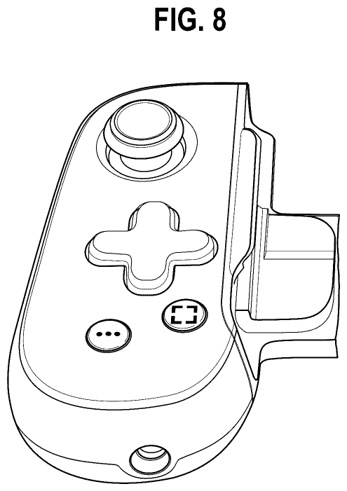

The speedbump is the opposite: tangent to the overhang top, sharp internal angle to the top case. The speedbump is better for comfort in the case that the thumb touches the overhang, as it avoids the sharp angle. There could be other designs also, that split the difference. As shown in FIGS. 3 and 8, the speedbump design has a J curve.

There can be ergonomic constraints to the “overhangs” as well. Concern about the overhangs emerged when internal testing showed that the thumb could contact the overhang when pressing the X button (right side) or the right lobe cardinal direction on the left side, or through the motion of the thumb stick. One implementation of an overhang design was described by a participant in a play test as “ . . . getting in the way during gameplay.” The ellipse 320 in FIG. 3 shows an above-average thumb size in the clicked and unclicked state. An internal analysis concluded that an overhang ramp angle larger than 140° is the upper bound of an ergonomic safe zone. The overall sculpt of the overhang was designed such that the thumb 320 would not make contact with a hard edge due to the smooth, continuous surface. In addition to the angle, we also determined that X distance from the overhang 210 to the X button 330 (see FIG. 3) was also a critical dimension to determine. We added extra space here in the design.

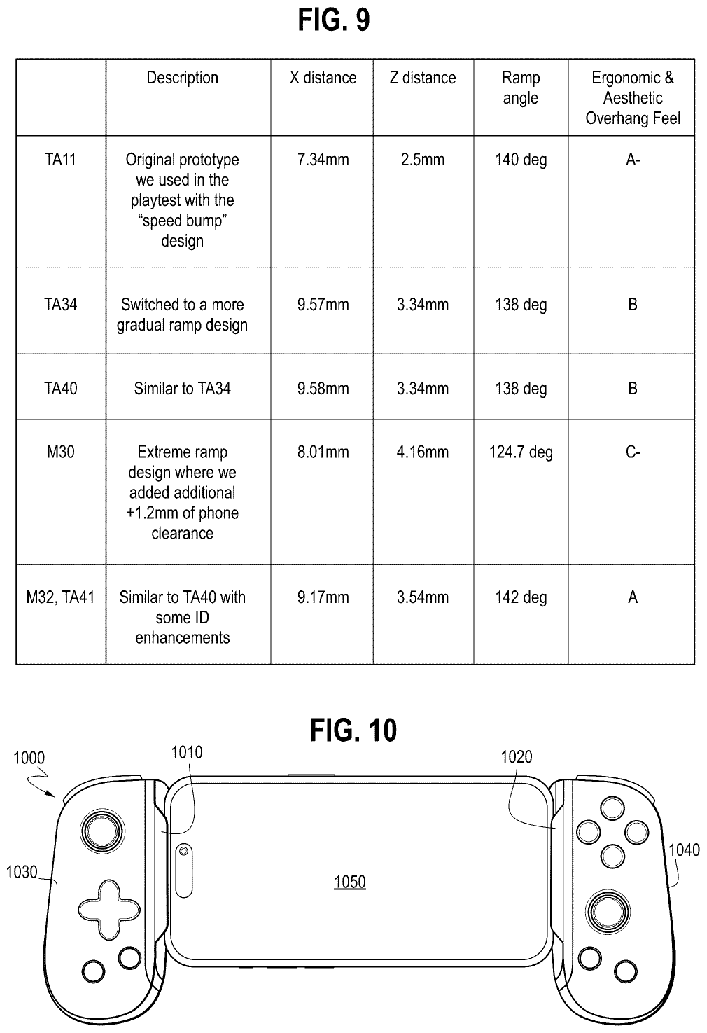

FIG. 9 is a chart of conclusions of various considered designs. In the first design, the ramp angle seems to make the largest impact on feel and impact to ergonomics and interference with the X button and aesthetics. Other designs will take this into account and keep the ramp angle larger than 140 degrees. In addition, when looking at the average thumb size, it does not seem like we have a major ergonomic issue here.

### Overhang Render

FIG. 10 is an illustration of a game controller 1000 of an embodiment that comprises overhangs 1010, 1020 on both handles 1030, 1040 of the game controller 1000. The overhangs 1010, 1020 grip a phone 1050.

### Y-Stack

Another critical dimension was the Y dimension of the overhang. The longer the overhang in Y, the less aesthetic the overall appearance given its prominence. Therefore, we optimized the dimension of the overhang in Y to the extent possible. It is increased by about 4 mm.

There are other embodiments that would have different advantages. For example, there could be multiple smaller overhangs (especially one at the top, and one at the bottom of the phone), rather than a single long overhang. These might be more challenging to incorporate aesthetically, but it depends on the overall design. One advantage of having space between two overhangs is that none of the phone would be covered in that space-possibly making phone interaction casier. Similarly, we tried (and rejected for aesthetic reasons) semi-circular cutouts in the overhang to allow for better phone interaction-especially edge swipe; however, those ideas are protected herein.

### Thumb Clearance—X and Z Positioning

Some of the biggest challenges to a good implementation of a phone overhang are aesthetics, proper phone security, and clearance to the hand to avoid any collisions, and the accompanying comfort or playability issues. Minimum clearance for an average thumb (e.g., 25 mm wide for males) should be in the 0.5 mm-5 mm range in the position where the thumb is closest to the overhang (e.g., when buttons are depressed, or directional controls are moved in that direction). Larger clearance than this will likely result in an oversized, bulky device. Some thumb collision is acceptable in extreme cases (e.g. unusually large thumbs or very non-conventional grip and playing styles)—excessive clearance will generally make the controller larger than it needs to be, adding weight, bulk, longer reaches to the touch screen, and reduced portability.

This clearance can be achieved a number of ways: (1) by the distance in X between the overhang peak and the nearest input affordance (e.g. button or joystick) in its closest position (e.g. button depressed or joystick pressed towards the overhang); by controlling the overhang curve shape to move the peak further from affordances; (2) by the distance in Y between the overhang and the nearest input affordance (e.g. button or joystick) (especially for the case when the overhang does not span a large vertical distance, or multiple overhangs are used); and (3) by keeping the Z height of the overhang lower than the affordance height.

Consequences of thumb collision with the overhang (again, in extreme cases) can be mitigated by reducing sharp radii in potential points of contact and using flexible materials to cushion impacts.

### New Top Surface Tilt

The top surface tilt is a new aspect of the design compared to the first-generation Backbone One game controller. To buy a bit of extra marginal space in the Z stack, we tilted the top surface the maximum we possibly could without resulting in (1) awkward highlights/pooling of light proximal to the joystick holes and (2) impacting aesthetics/ergonomics in a noticeable way. This angle (3.56 degree top case angle) is captured in FIG. 11. The approximate maximum value for this is 4 degrees from horizontal. Repositioning the joystick closer towards the center of the device also affects the way that light pools, and results in strange highlights.

### New Rounded Top Perimeter

The rounded top perimeter is a new aspect of the design compared to the first-generation Backbone One game controller. In order to improve comfort while preserving the top perimeter outline that has defined Backbone's iconic, era-defining design language in the eyes of consumers globally since its introduction in October 2020, we have increased the radius of the top perimeter, and the variable radius rounds.

### Phone Security

A purpose of the overhang is to safely secure the phone in the controller. Mechanical requirements to meet this purpose are: (1) 2-6 mm (2.70 minimum in one embodiment) of overhang on the phone to properly secure it in the X-direction; (2) 0.9-3 mm (1.31 minimum in one embodiment) of overhang thickness for stiffness and manufacturability; (3) 30-55 mm (34.33 in one embodiment) of total Y-dimension for security and durability (one or more overhangs); and (3) high friction, tacky elastomer or soft-touch paint, such as TPE, silicone or polyurethane (TPE in one embodiment).

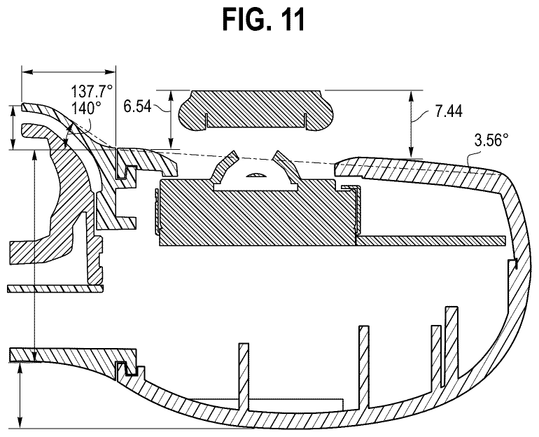

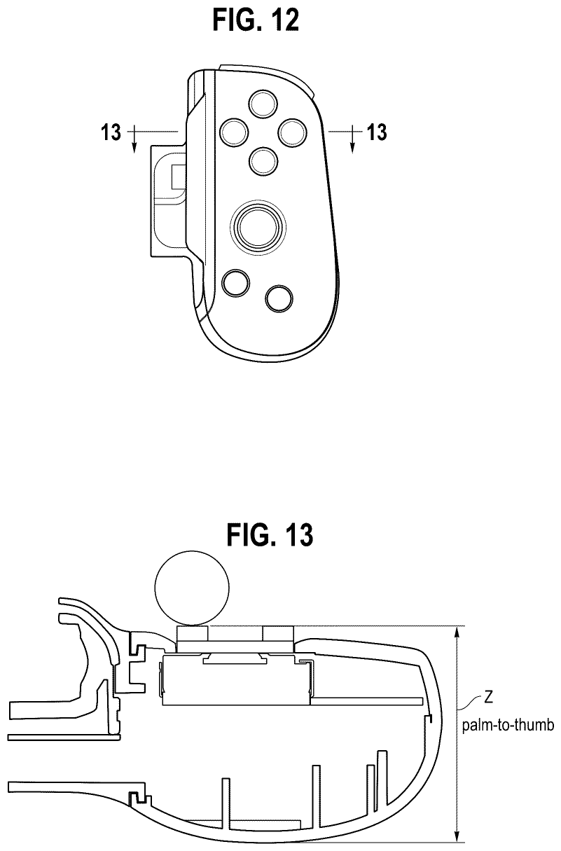

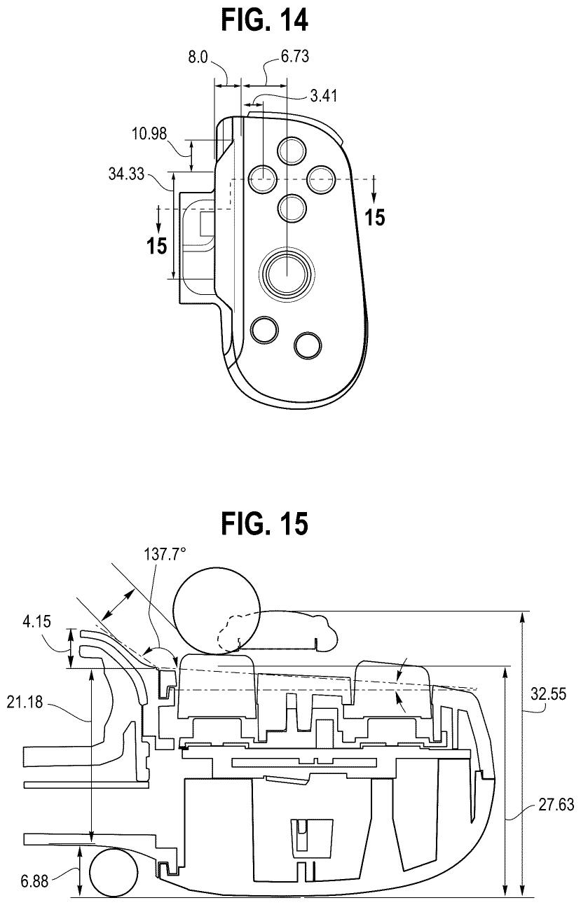

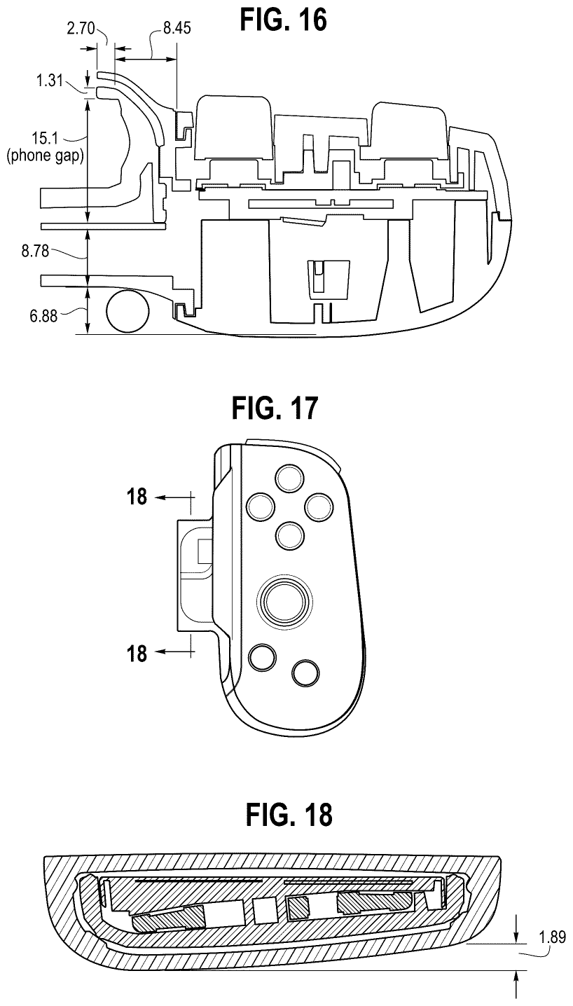

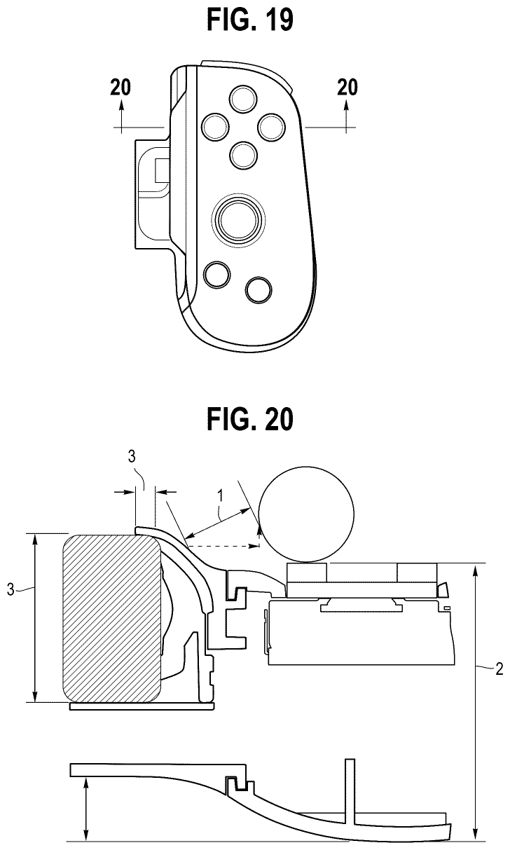

Turning again to the drawings. FIGS. 12 and 13 illustrate a thumb flexion problem. FIGS. 14 and 15 illustrate an ergonomic critical Z stack. FIGS. 16-18 illustrate a mechanical critical Z stack. FIGS. 19-20 illustrate an ergonomic framework. In this framework, reference number 1 is the thumb clearance to OH, reference number 2 is the thumb flexion input Z location, and reference number 3 represents the phone security versus coverage. The critical dimensions to reference number 1 are [XY] input-to-overhang, [Z] input depressed-to-overhang, and surface profile at zero thumb clearance (tangent). The critical dimensions to reference number 2 are [Z] top of input surface to bottom of handle (palm-to-thumb X). The critical dimensions to reference number 3 are [XY] X datum-to-touchscreen and [Z] maximum phone thickness.

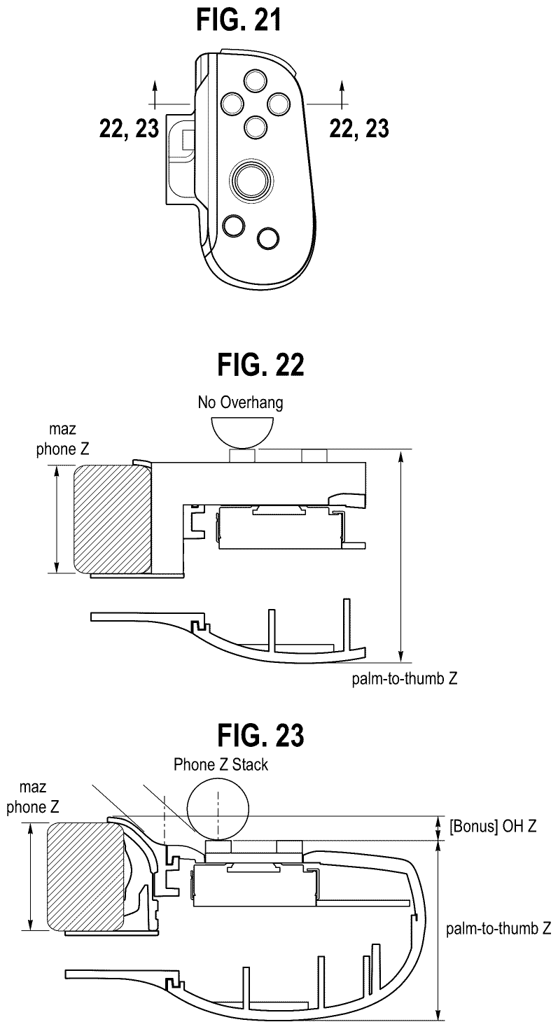

FIGS. 21-23 illustrate a thumb flexion problem. The top-level problem statement is how to design a gaming product accommodating phones and case thicknesses with good hand comfort. Other embodiments are possible and are protected herein. A broad scope of protection includes the palm-to-thumb Z combined with hand comfort.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

What is claimed is:

1. A game controller for a mobile device, the game controller comprising:
a first handle; and
a second handle;
wherein the first handle comprises:
at least one user input device;
a top surface; and
an overhang elevated above the top surface of the first handle and configured to contact a top portion of a mobile device positioned between the first and second handles, wherein the overhang comprises a notched-out thumb-clearance region.

2. The game controller of claim 1, wherein the overhang comprises an S-curve.

3. The game controller of claim 1, wherein the overhang comprises a J-curve.

4. The game controller of claim 1, wherein a length of the overhang in a Y direction is less than a length of the mobile device in the Y direction.

5. The game controller of claim 1, wherein a length of the overhang in a Y direction is less than a length of the first handle in the Y direction.

6. The game controller of claim 1, wherein the first handle comprises at least one additional overhang configured to contact at least one additional top portion of the mobile device.

7. The game controller of claim 1, wherein the notched-out thumb-clearance region provides 0.5 mm to 5 mm of thumb clearance.

8. The game controller of claim 1, wherein the overhang is positioned away from a grip area of the first handle.

9. The game controller of claim 1, wherein the second handle comprises a second overhang configured to contact another top portion of the mobile device.

10. The game controller of claim 1, wherein the top surface of the first handle is tilted at an angle.

11. The game controller of claim 10, wherein the angle is at about four degrees.

12. The game controller of claim 11, wherein the angle is about 3.56 degrees.

13. The game controller of claim 1, wherein a size of the overhang in an X direction is about 2 mm to 6 mm.

14. The game controller of claim 1, wherein a size of the overhang in a Y direction is about 30 mm to 55 mm.

15. A game controller for a mobile device, the game controller comprising:
a first handle;
a second handle; and
a bridge coupling the first and second handles;
wherein:
the first and second handles each comprise a respective:
top handle surface;
first coupling surface adjacent to the bridge; and
second coupling surface raised above the top handle surface and the first coupling surface, wherein the first and second coupling surfaces are configured to mechanically secure, to the game controller, a mobile phone positioned between the first and second coupling surfaces; and
the second coupling surfaces of the first and second handles are symmetrical and both have a length of at least 2 mm.

16. The game controller of claim 15, wherein the second coupling surfaces of the first and second handles have a length of 2-6 mm in the X direction.

17. The game controller of claim 15, wherein the second coupling surfaces of the first and second handles have a thickness of at least 0.9 mm.

18. The game controller of claim 17, wherein the second coupling surfaces of the first and second handles have a thickness of 0.9-3 mm.

19. The game controller of claim 15, wherein the second coupling surfaces of the first and second handles both have a length of 30-55 mm in a Y direction.

20. The game controller of claim 15, wherein the first handle further comprises at least one additional coupling surface raised above the top handle surface and the first coupling surface.

21. The game controller of claim 15, wherein the second coupling surface comprises an overhang.

22. A game controller comprising:
a first handle comprising a first plurality of user input devices; and
a second handle comprising a second plurality of user input devices;
wherein the first handle comprises:
a top surface; and
an overhang elevated above the top surface and configured to contact a top portion of a mobile device positioned between the first and second handles, wherein a ramp angle between the top surface and the overhang is at least 140 degrees.

23. The game controller of claim 22, wherein the ramp angle is 142 degrees.
